(19) United States
(12) Patent Application Publication
(10) Pub. No.: US 2010/0323250 A1
(43) Pub. Date: Dec. 23, 2010

(54) DESULFURIZING SYSTEM FOR A FUEL CELL POWER PLANT

(76) Inventors: Thomas H. Vanderspurt, Glastonbury, CT (US); Zissis Dardas, Worcester, MA (US); Xia Tang, West Hartford, CT (US); Caroline A. Newman, Washington, DC (US); Ying She, Worcester, MA (US)

Correspondence Address: Malcolm J Chisholm Jr, P O Box 278, Lee, MA, 01238, US

(21) Appl. No.: 12/735,661

(22) PCT Filed: Apr. 1, 2008
(86) PCT No.: PCT/US08/04254

§ 371 Date: Aug. 5, 2010

(51) Int. Cl. H01M 8/06

(52) U.S. Cl. 429/410

(57) ABSTRACT

The system (40) provides for directing a hydrogen-rich reformate fuel stream from a reformer (42) through a sulfur removal bed (50) having a sulfur removal material consisting of manganese oxide secured to a support material. A regeneration fluid is intermittently directed through the bed (50) to remove sulfur and regenerate the bed. A regeneration-produced sulfur containing stream is then directed into a sulfur capture bed (54) having a heat source (60) and a flush inlet (62) and flush outlet (64). The sulfur capture bed (54) includes sulfur capture material consisting of nickel oxysulfide catalyst supported on silicon carbide. When the heat source (60) heats the sulfur capture bed (54) a flush liquid passed through the flush inlet (62), capture bed (54), and flush outlet (64) to transport elemental sulfur to a sulfur storage container (50).

### TECHNICAL FIELD

The present disclosure relates to fuel cells that are suited for usage in transportation vehicles, portable power plants, or as stationary power plants, and the disclosure especially relates to an improved system for removing sulfur from a fuel for a fuel cell power plant.

### BACKGROUND ART

Fuel cells are well known and are commonly used to produce electrical current from hydrogen containing reducing fluid fuel and oxygen containing oxidant reactant streams to power electrical apparatus or to serve as electricity generators. As is well known in the art, a plurality of fuel cells are typically stacked together to form a fuel cell stack assembly which is combined with controllers and other components to form a fuel cell power plant.

In fuel cells of the prior art, it is well known that utilization of auto-thermal reformers and/or partial oxidation catalytic reformers enables traditional hydrocarbon fuels, such as gasoline, diesel fuel, distillate fuels, natural gas, liquefied petroleum gas, etc. to be converted by such reformers into a gaseous, hydrogen-rich reformate fuel stream that can be utilized by a fuel cell along with an oxidant rich stream to produce electricity. However, for solid oxide electrolyte fuel cell (“SOFC”) power plants that operate at extremely high temperatures, as well as for proton exchange membrane electrolyte fuel cell (“PEM”) power plants operating on a high temperature reformate fuel stream, efficient removal of sulfur from fuel remains a significant problem.

### SUMMARY

The disclosure is directed to a desulfurizing system for a fuel cell power plant operating on a sulfur-containing fuel. The power plant has at least one fuel cell for generating electrical current from a gaseous, hydrogen-rich reformate fuel stream and an oxidant stream. The desulfurizing system includes a reformer secured in fluid communication through a fuel feed line with a fuel source for reforming the fuel into the gaseous, hydrogen-rich reformate fuel stream. The reformer is also secured in fluid communication with a gaseous fuel inlet line for directing the gaseous reformate fuel stream into the fuel cell. A sulfur removal bed is secured in fluid communication with and between the reformer and the fuel cell. The sulfur removal bed includes sulfur removal material consisting of manganese oxide secured to a support material and the bed is configured to direct flow of the gaseous reformate fuel stream adjacent the sulfur removal material to remove sulfur from the gaseous reformate fuel stream.

The desulfurizing system also includes a sulfur capture bed secured in fluid communication with the sulfur removal bed. The sulfur capture bed includes sulfur capture material consisting of nickel oxysulfide catalyst supported on silicon carbide. The sulfur capture bed is configured to direct flow of a regeneration-produced sulfur containing stream from the sulfur removal bed through the sulfur capture bed adjacent the sulfur capture material. The sulfur capture bed includes a heat source configured to intermittently heat the bed. The sulfur capture bed also includes a flush inlet and flush outlet configured to permit a flush liquid to intermittently pass through the bed and adjacent the sulfur capture material. A sulfur storage container is secured in fluid communication with the flush outlet of the sulfur capture bed for storing sulfur flushed with the flush liquid from the sulfur capture bed.

In ordinary operation of a fuel cell power plant utilizing the present desulfurizing system, as the fuel passes through the sulfur removal station, sulfur within the fuel, primarily in the form of hydrogen sulfide, is adsorbed on the support material and converts manganese oxide to manganese sulfide to thereby remove the sulfur from the fuel stream. After a predetermined amount of sulfur has been removed from the reformate fuel stream within the sulfur removal bed, flow of fuel from the bed to the fuel cell is terminated and the bed is regenerated by passing a steam and oxygen containing gas through the bed. Oxygen may be supplied from the air or any other source. The steam and oxygen convert the sulfur back to gaseous hydrogen sulfide, and regenerate the manganese sulfide back to manganese oxide so the sulfur removal bed may be used again to remove sulfur. The gaseous hydrogen sulfide is directed into the sulfur capture bed where in the presence of the steam and air the hydrogen sulfide is oxidized to elemental sulfur over the nickel oxysulfide. The sulfur capture bed is then heated to between about one hundred ten and about one hundred thirty degrees Celsius as the flush liquid, such as water, is passed through the sulfur capture bed causing the elemental sulfur to be washed off the sulfur capture material with the flush liquid into the sulfur storage container. The desulfurizing system therefore provides an efficient and safe apparatus and method for removing sulfur from the fuel and storing the sulfur so that it is not released into the environment.

It has been found that the sulfur removal material is so effective at removing sulfur from the fuel, especially in very high temperature reformate fuel streams at between about four hundred and about one-thousand degrees Celsius, that regeneration of the sulfur removal bed is not always necessary. For example, in an alternative embodiment of the desulfurizing system, the sulfur removal bed may be dimensioned to remove sulfur for a predetermined duration, and then the sulfur removal bed is simply replaced with another sulfur removal bed. Such an embodiment may be appropriate for specific fuel cell operational requirements, such as when a fuel cell power plant is operating on very low-sulfur content fuels, and replacement sulfur removal beds are available at a modest cost. In this embodiment, the desulfurization system does not include the sulfur capture bed or the sulfur storage container.

Alternatively, the desulfurizing system may be utilized in a fuel cell power plant that will be operating for extended durations followed by periods of the plant being shut down. For such a power plant, during a shut down of the fuel cell, the above described regeneration of the sulfur removal bed would take place, including removal of the sulfur to the sulfur capture bed and storage container. In an additional embodiment, requirements of the power plant may not afford a shut-down period suitable for regeneration of the sulfur removal bed. Consequently, the desulfurizing system would include a first sulfur removal bed and a second sulfur removal bed operating essentially in an alternate, parallel deployment. For example, whenever the first sulfur removal bed is controlled to permit the reformate fuel to pass through the bed for sulfur removal and to then pass into the fuel cell, the second sulfur removal bed would be controlled to prohibit flow of fuel into the bed so that it could be regenerated in the manner described above.

In a preferred embodiment the sulfur removal material includes the manganese oxide dispersed over and secured to MnAl₂O₄ as the support material. The common name of MnAl₂O₄ is galaxite. Other high surface area, large pore refractory aluminates may also be used. These include, but are not limited to, spinel (MgAl₂O₄) and calcium aluminate (CaAl₂O₄). However, galaxite is preferred because it limits the conversion of manganese oxide to other less reactive minerals on repeated cycles of sulfide capture and regeneration. Additionally, the sulfur removal material is steam, carbon monoxide, carbon dioxide and hydrogen stable, and the manganese oxide is typically dispersed over a highly porous support material. In a further embodiment, the sulfur capture material within the sulfur capture bed may include the silicon carbide support having some meso-pore regions treated to be hydrophilic to facilitate forming and capturing the elemental sulfur from the hydrogen sulfide in the regeneration-produced sulfur containing stream. The silicon carbide support material may also have multi modal pore size distribution with some pores hydrophilic and other pores hydrophobic to facilitate collection of the captured sulfur and to facilitate transport of the collected sulfur by way of a water film on the support material that is in fluid communication with the flush liquid for transporting the sulfur to the sulfur storage container.

Accordingly, it is a general purpose of the present disclosure to provide a desulfurizing system for a fuel cell power plant that overcomes deficiencies of the prior art.

It is a more specific purpose to provide a desulfurizing system for a fuel cell power plant that removes virtually all sulfur from the fuel and prevents the removed sulfur from entering the environment.

These and other purposes and advantages of the present desulfurizing system for a fuel cell power plant will become more readily apparent when the following description is read in conjunction with the accompanying drawings.

### BRIEF DESCRIPTION OF DRAWING

FIG. 1 is a simplified schematic representation of a fuel cell power plant including a desulfurizing system constructed in accordance with the present disclosure.

FIG. 2 is a simplified schematic representation of an alternative embodiment of a desulfurizing system of the present disclosure showing the system having two sulfur removal beds.

### DESCRIPTION OF THE PREFERRED EMBODIMENTS

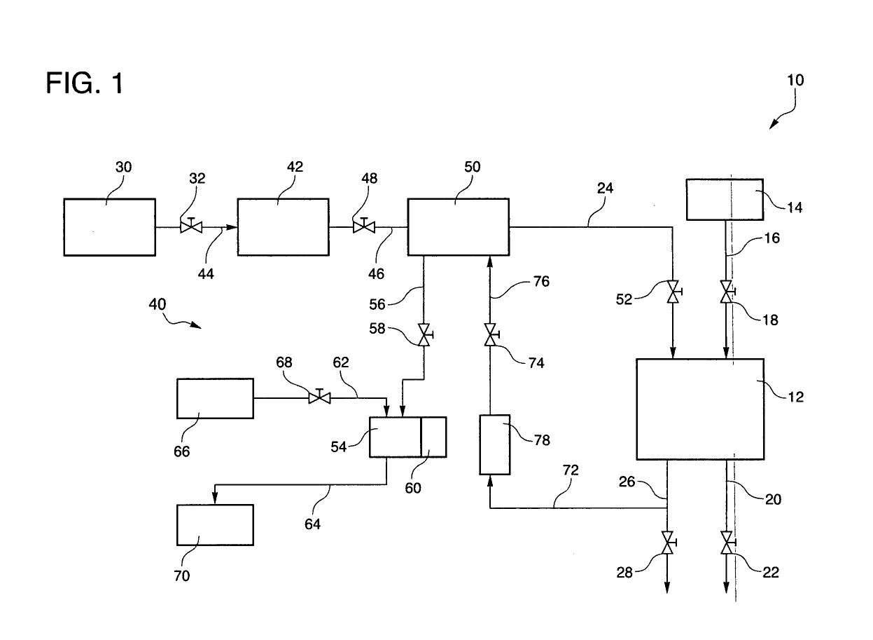

Referring to the drawings in detail, a desulfurizing system for a fuel cell power plant is shown in FIG. 1. The fuel cell power plant is generally designated by the reference numeral 10. The power plant 10 includes at least one fuel cell 12 as part of the fuel cell power plant 10. An oxidant supply source 14 directs flow of an oxygen rich oxidant reactant stream through an oxidant inlet line 16 and oxidant inlet valve 18 into the fuel cell 12, and unused oxidant passes out of the fuel cell 12 through an oxidant exhaust line 20 and oxidant exhaust valve 22. A fuel inlet line 24 directs a gaseous, hydrogen-rich reformate fuel stream into the fuel cell 12, and unused fuel passes out of the fuel cell 12 through a fuel exhaust line 26 and fuel exhaust valve 28. The fuel cell 12 is configured to produce electricity as the fuel and oxidant reactant streams flow through the fuel cell 12. The fuel cell power plant 10 also includes a fuel source 30 for storing a sulfur-containing fuel, such as gasoline, diesel fuel, etc., that is reformed into the gaseous, hydrogen-rich reformate fuel stream. The stored fuel may be selectively directed out of the fuel source 30 through a fuel inlet valve 32 secured in fluid communication with the fuel source 30.

The desulfurizing system is generally designated by the reference numeral 40 in FIG. 1. The system 40 includes a reformer 42 secured in fluid communication through a fuel feed line 44 with the fuel source 30. The reformer 42 may be any reformer for reforming a hydrocarbon fuel into a gaseous, hydrogen-rich reformate fuel stream, such as an auto thermal reformer, partial oxidation catalytic reformer, etc. The reformer 42 is also secured in fluid communication with a feed extension 46 of the fuel inlet line 24 for directing the gaseous reformate fuel stream from the reformer 42 into the fuel cell 12. The feed extension 46 of the fuel inlet line 24 may include a reformer isolation valve 48 to selectively permit or restrict flow through valve 48.

A sulfur removal bed 50 is secured in fluid communication with and between the reformer 42, by way of the feed extension 46 of the fuel inlet line 24, and the fuel cell 12 by way of the fuel inlet line 24. The sulfur removal bed 50 houses sulfur removal material consisting of manganese oxide secured to a support material and the bed 50 is configured to direct flow of the gaseous reformate fuel stream adjacent the sulfur removal material to remove sulfur from the gaseous reformate fuel stream. The reformate fuel stream is directed from the sulfur removal bed 50 through the fuel inlet line 24 and a fuel inlet valve 52 into the fuel cell 12. The sulfur removal material is manganese oxide (MnO) supported on a high surface area large pore, refractory support with less affinity for sulfide than for MnO. The support material has to be compatible with both MnO and manganese sulfide (MnS) and be capable of withstanding regeneration conditions wherein manganese sulfide is reconverted to manganese oxide in the presence of steam.

The desulfurizing system also includes a sulfur capture bed 54 secured in fluid communication with the sulfur removal bed 50 through a sulfur capture bed feed line 56 having a sulfur capture bed inlet valve 58. The sulfur capture bed 54 includes sulfur capture material consisting of a nickel oxysulfide catalyst supported on silicon carbide. The sulfur capture bed 54 receives a regeneration-produced sulfur containing stream from the sulfur removal bed 50. The sulfur capture bed is configured to direct flow of the sulfur containing stream through the sulfur capture bed 54 adjacent the sulfur capture material. The sulfur capture bed 54 also includes a heat source 60 configured to intermittently heat the bed 54. The sulfur capture bed 54 also includes a flush inlet 62 and flush outlet 64 configured to permit a flush liquid to intermittently pass through the bed 54 and adjacent the sulfur capture material. The flush liquid may be hot pressurized water and may be delivered to the flush inlet 62 from a flush liquid storage source 66 through a flush liquid feed valve 68 into the flush inlet 62.

A sulfur storage container 70 is secured in fluid communication with the flush outlet 64 of the sulfur capture bed 54 for storing sulfur flushed with the flush liquid from the sulfur capture bed 54. The desulfurizing system 40 may also include a fuel exhaust feed line 72 having a fuel exhaust feed valve 74 secured to the feed line 72 wherein the fuel exhaust feed line is secured in fluid communication between the fuel exhaust 26 exiting the fuel cell 12 and a regeneration-fluid inlet 76 of the sulfur removal bed 50 for selectively directing all or a portion of the fuel exiting the fuel cell 12 into the sulfur removal station 50. The fuel exhaust feed line 72 may also direct a portion of the fuel exhaust into a fuel exhaust storage container 78 for use of the stored fuel exhaust as a regeneration fluid when the fuel cell 12 is not operating. The regeneration fluid must be at a higher temperature than the desulfurization operation temperature within the sulfur removal bed 50 and must contain a higher water (steam) partial pressure than the water partial pressure within the sulfur removal bed 50. Spent fuel exhaust from the fuel cell 12 that has passed over an oxidation catalyst with sufficient air to oxidize the remaining fuel and raise its temperature, such as within the fuel cell exhaust storage container 78, may be utilized as a regeneration fluid (For purposes herein, the word “selectively” is to mean that a described function or apparatus may be controlled to do or not do a described function, or to be in or to not be in a described configuration or operational mode, such as with respect to described valves, etc.)

In operation of the desulfurizing system shown in FIG. 1, the hydrogen-rich fuel passes from the reformer 42 through fuel feed line 46 and open reformer isolation valve 48 into the sulfur removal bed 50. The sulfur capture bed inlet valve 58 would be closed as would the regeneration fluid inlet 76 such as by closing the fuel exhaust feed valve 74. The fuel inlet valve 52 would be open and the reformate fuel stream would flow from the sulfur removal bed 50 into the fuel cell 12 to produce electricity.

Whenever the sulfur removal bed 50 can no longer efficiently remove sulfur, or at predetermined intervals, the fuel inlet valve 52 would be closed and the reformer isolation valve 48 would also be closed. Then, a regeneration fluid would be directed to flow into the regeneration-fluid inlet 76 of the sulfur removal bed 50, such as through the fuel exhaust feed valve 74 from the fuel exhaust storage container 78 or any other regeneration fluid source (not shown). Simultaneously, the sulfur capture bed inlet valve 58 would be open to permit flow of a regeneration-produced sulfur containing stream from the sulfur removal bed 50 into the sulfur capture bed 54. After a predetermined duration adequate to remove sulfur from and regenerate the sulfur removal bed 50, the sulfur capture bed inlet valve would be closed, the fuel exhaust feed valve 58 would be closed and the reformer isolation valve 48 and fuel inlet valve 52 would be opened to permit flow of the reformate fuel stream into the fuel cell 12. The heat source 60 would be controlled to raise a temperature of the sulfur capture bed 54 to between about one hundred and ten and one hundred and thirty degrees Celsius. Then the flush liquid would be directed to flow from its storage source 66 through the flush inlet 62, sulfur capture bed 54 and flush exit 64 into the sulfur storage container 70 to safely store the sulfur removed from the fuel.

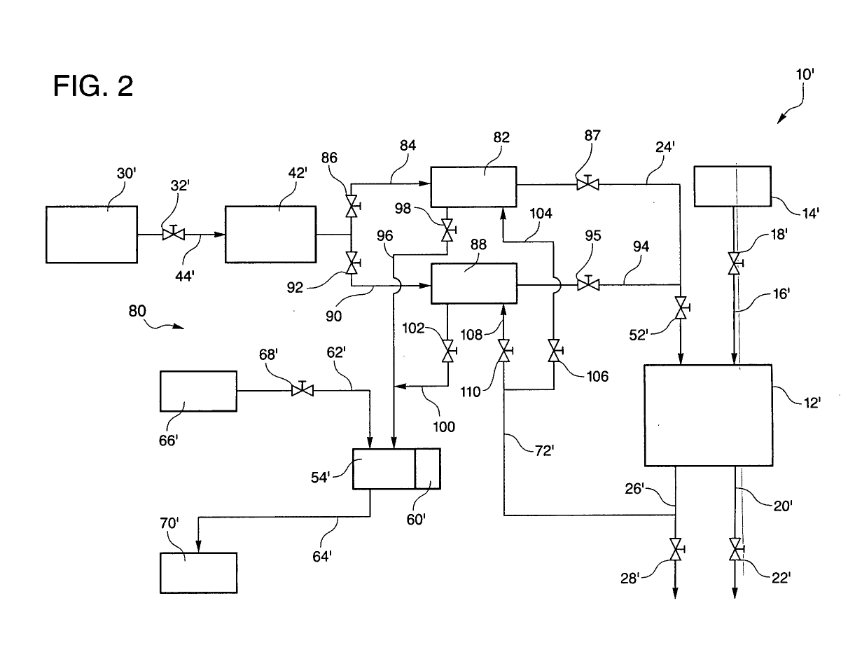

An alternate embodiment of the desulfurizing system of the present disclosure is shown in FIG. 2 and is generally designated by the reference numeral 80 and may be referred to for convenience as a parallel sulfur removal bed embodiment 80. (Components of the alternate embodiment of the desulfurizing system 80 and power plant 10′ that are virtually identical to components shown in the FIG. 1 embodiment are designated by primes of the reference numerals used in FIG. 1, and descriptions of those components are not repeated below, for purposes of efficiency. For example, the fuel cell 12 in FIG. 1 is designated as a fuel cell 12′ in FIG. 2.)

The parallel sulfur removal bed embodiment includes a first sulfur removal bed 82 secured in fluid communication through a first feed extension line having first reformer isolation valve 86 with the reformer 42′. The first sulfur removal bed 82 is also secured in fluid communication with the fuel cell 12′ through a fuel inlet line 24′, first fuel cell isolation valve 87 on the line 24′, and the fuel cell 12′. A second sulfur removal bed 88 is also secured in fluid communication with reformer 42′ through a second feed extension line 90 and second reformer isolation valve 92. The second sulfur removal bed 88 is also secured in fluid communication through a second fuel inlet line 94, second fuel cell isolation valve 95 on the line 94, and with the fuel inlet line 24′ and fuel cell 12′.

The first sulfur removal bed 82 is also secured in fluid communication with the sulfur capture bed 54′ by way of a first sulfur capture feed line 96 and first sulfur capture bed inlet valve 98. The second sulfur removal bed 88 is also secured in fluid communication with the sulfur capture bed 54′ through a second sulfur capture bed feed line 100 and second sulfur capture bed inlet valve 102. The first sulfur removal bed 82 includes a first regeneration-fluid inlet 104 that may be secured in fluid communication through a first fuel exhaust feed valve 106 for selectively admitting hydrogen within fuel exhaust from the fuel cell exhaust line 26′. The second sulfur removal bed 88 similarly includes a second regeneration-fluid inlet 108 that may be secured in fluid communication through second fuel exhaust feed valve 110 with the fuel cell exhaust line 26′. The first and second regeneration-fluid inlets 104, 108, may also be secured with alternate sources (not shown) of fluids capable of regenerating the first and/or second removal beds 82, 88, such as water that is initially free of sulfur and that is at a temperature greater than a temperature within the sulfur removal beds 82, 88, and that is at a higher partial pressure than water within the sulfur removal beds 82, 88.

In operation of the parallel sulfur removal bed embodiment 80 of the desulfurizing system, a controller not shown, would control one of the first sulfur removal bed 82 or the second sulfur removal bed 88 to direct flow of the reformate fuel stream through the bed 82 or 88 and into the fuel cell 12′. Simultaneously, the bed 82, 88, that is not directing flow of the reformate fuel stream would be controlled so that the reformer isolation valve 86 or 92, in fluid communication with the bed not directing flow of the fuel stream would be closed to prohibit flow of any fluid through the valve 86, 92. For example, if the sulfur removal bed 82 is directing flow of the reformate fuel stream through the bed 82 and onto the fuel cell 12′, the first reformer isolation valve 86 would be open, the first fuel cell isolation valve 87 would be open, the first fuel exhaust feed valve 106 would be closed, the first sulfur capture bed inlet valve 98 would be closed, the second reformer isolation valve 92 would be closed, and the second fuel cell isolation valve 95 would also be closed.

When it is desired to remove sulfur from and regenerate the second sulfur removal bed 88, a regeneration fluid would be directed through the second regeneration-fluid inlet 108 into the second sulfur removal bed 88. The regeneration fluid may be a portion of the fuel cell exhaust and may be admitted through the second fuel exhaust feed valve 110. Simultaneously, the second sulfur capture bed inlet valve 102 would be open to permit flow of a regeneration produced sulfur containing stream from the second sulfur removal bed 88 into the sulfur capture bed 54′. After a predetermined duration of directing flow of the regeneration fluid through the second bed 88 valves 102 and 108 would be closed. Then the heat source 60′ would heat the sulfur capture bed 54′ to between about one hundred and ten and about one hundred and thirty degrees Celsius, and a flush liquid would be directed to flow from the flush liquid source 66′ through the sulfur capture bed 54′ to remove elemental sulfur and store it within the sulfur storage container 70′. (For purposes herein, the word “about” is to mean plus or minus twenty percent.)

Whenever the first sulfur removal bed 82 can no longer efficiently remove sulfur, the reformate fuel stream would be directed to flow through the regenerated second sulfur removal bed 88 by opening the second reformer isolation valve 92 and the second fuel cell isolation valve 95, while closing the first reformer isolation valve 86 and closing the first fuel cell isolation valve 87. Then, whenever it is desired to remove sulfur from and regenerate the first sulfur removal bed 82 the regeneration fluid would be directed through the first regeneration fluid inlet 104, through the first sulfur removal bed 82, and through the first sulfur capture bed feed line 96 into the sulfur capture bed 54′. The sulfur capture bed 54′ would then be heated and flushed as described above to remove sulfur from the capture bed 54′ into the sulfur storage container 70′.

The desulfurizing system 40, 80 also includes controller means (not shown) for controlling the described valves and other components of the system 40, 80 and power plant 10, 10′ to perform functions described herein. The controller may be any controller for performing the described functions in response to control signals, sensed information, etc., by manual controls, electro-mechanical controls, computer-generated control signals transmitted to mechanical or electro-mechanical control apparatus, etc.

A further embodiment of the present desulfurizing system 40 includes the reformer 42, sulfur removal bed 50 alone, without the sulfur capture bed 54 or sulfur storage container 70. This embodiment would be appropriate for a fuel cell power plant 10 operating on extremely low sulfur fuels, or other operational requirements that permit intermittent replacement of the sulfur removal bed 50. It has been found that use of the sulfur removal material including manganese oxide is so remarkably effective at removing sulfur that the sulfur removal bed may remove an amount of sulfur from the fuel which amounts to about twenty percent of the weight of the sulfur removal material. Therefore for certain fuel cell power plants, no regeneration would be required, or intermittent replacement of the sulfur removal bed 50 would provide adequate efficiency.

The desulfurizing system 40, 80, of the present disclosure also includes a method of desulfurizing fuel for the fuel cell power plant 10. The method includes the steps of directing a sulfur containing hydrogen-rich reformate fuel stream from a reformer into and through a sulfur removal bed 50, passing the reformate fuel stream adjacent sulfur removal material consisting of manganese oxide secured to a support material within the sulfur removal bed 50, directing the reformate fuel stream from the bed into a fuel cell 12, intermittently directing flow of a regeneration fluid through the sulfur removal bed 50 to remove sulfur from and regenerate the sulfur removal bed 50, directing flow of a regeneration-produced sulfur containing stream from the sulfur removal bed 50 through a sulfur capture bed 54 containing sulfur capture material consisting of a nickel oxysulfide catalyst supported on silicon carbide, then heating the sulfur capture material to between about one hundred and ten and about one hundred and thirty degrees Celsius while flushing a flush liquid through the sulfur capture bed 54, then directing flow of the flush liquid containing sulfur from the sulfur capture bed 54 to a sulfur storage container 70. The present disclosure also includes the methods of operating the parallel sulfur removal bed embodiment 80 as described above.

In a further preferred embodiment the sulfur removal material within the sulfur removal bed 50, 82, 88 includes the manganese oxide dispersed over and secured to MnAl₂O₄ as the support material. The support material may also include any high surface area large pore, refractory support with less affinity for sulfide than for MnO. The support material also has to be compatible with both MnO and manganese sulfide (MnS) and be capable of withstanding regeneration conditions wherein manganese sulfide is reconverted to manganese oxide in the presence of steam. The sulfur removal material is also manufactured to be stable in the presence of steam, carbon monoxide, carbon dioxide and hydrogen. Moreover, the manganese oxide is typically dispersed over a highly porous support material. In a further embodiment, the sulfur capture material within the sulfur capture bed 54, 54′ may include the silicon carbide support having some meso-pore surface regions treated to be hydrophilic to facilitate forming and capturing the elemental sulfur from the hydrogen sulfide in the regeneration-produced sulfur containing stream. The silicon carbide support material may also have some other surface regions outside of the pores treated to be hydrophobic to facilitate collection of the captured sulfur and to facilitate transport of the collected sulfur by way of a water film on the support material that is in fluid communication with the flush liquid for transporting the sulfur to the sulfur storage container 70, 70′.

While the present disclosure has been presented with respect to the described and illustrated desulfurizing system 40, 80 for a fuel cell power plant 10, 10′, it is to be understood that the disclosure is not to be limited to those alternatives and described embodiments. For example, the desulfurizing system 40, may be utilized with any fuel cells including preferably solid oxide fuel cells, as well as phosphoric acid fuel cells, proton exchange membrane fuel cells, etc. Accordingly, reference should be made primarily to the following claims rather than the forgoing description to determine the scope of the disclosure.

What is claimed is:

1. A desulfurizing system (40) for a fuel cell power plant (10) operating on a sulfur-containing fuel, the power plant (10) having at least one fuel cell (12) for generating electrical current from a gaseous, hydrogen-rich reformate fuel stream and an oxidant stream, the desulfurizing system (40) comprising:
a. a reformer (42) secured in fluid communication through a fuel feed line (44) with a fuel source (30) for reforming the sulfur-containing fuel into the gaseous, hydrogen-rich reformate fuel stream, and the reformer (30) secured in fluid communication with a gaseous fuel inlet line (24) for directing the gaseous reformate fuel stream into the fuel cell (12);
b. a sulfur removal bed (50) secured in fluid communication with and between the reformer (42) and the fuel cell (12), the sulfur removal bed (50) including sulfur removal material consisting of manganese oxide secured to a support material and configured to direct flow of the gaseous reformate fuel stream adjacent the sulfur removal material to remove sulfur from the gaseous reformate fuel stream; and,
c. the fuel inlet line (24) being secured in fluid communication between the sulfur removal bed (50) and the fuel cell (12) configured for directing flow of the gaseous, hydrogen-rich reformate fuel stream from the sulfur removal bed (50) into the fuel cell (12).

2. The desulfurizing system (40) of claim 1, further comprising:
a. the sulfur removal bed (50) including a regeneration-fluid inlet (76) configured to intermittently direct flow of a regeneration fluid through the sulfur removal bed (50) adjacent the sulfur removal material;
b. a sulfur capture bed (54) secured in fluid communication with the sulfur removal bed (50), the sulfur capture bed (54) including sulfur capture material consisting of nickel oxysulfide catalyst supported on silicon carbide and configured to direct flow of a regeneration-produced sulfur containing stream from the sulfur removal bed (50) through the sulfur capture bed (54) adjacent the sulfur capture material, the sulfur capture bed including a heat source (60) configured to heat the bed, and the sulfur capture bed (54) including a flush inlet (62) and flush outlet (64) configured to direct flow of a flush liquid to intermittently pass through the bed (54) and adjacent the sulfur capture material; and,
d. a sulfur storage container (70) secured in fluid communication with the flush outlet (64) of the sulfur capture bed (54) for storing sulfur flushed with the flush liquid from the sulfur capture bed (54).

3. The desulfurizing system (40) of claim 2 further comprising a fuel exhaust feed line (72) secured in fluid communication with one of a fuel exhaust line (26) configured to direct a fuel exhaust out of the fuel cell (12) or a fuel exhaust storage container (78) configured to store a portion of the fuel exhaust of the fuel cell (12), the fuel exhaust feed line (72) also secured in fluid communication with the regeneration-fluid inlet (76) and configured to intermittently direct fuel exhaust into the sulfur removal bed (50) to remove sulfur from and regenerate the sulfur removal bed (50).

4. The desulfurizing system of claim 2, wherein the sulfur capture material within the sulfur capture bed (54) further comprises the silicon carbide support defining hydrophilic surface regions configured to capture elemental sulfur from the regeneration-produced sulfur containing stream passing through the sulfur capture bed (54), and the silicon carbide support material defining hydrophobic surface regions configured for collection of the captured sulfur within a water film on the support material in fluid communication with the flush liquid transporting the sulfur to the sulfur storage container (70).

5. The desulfurizing system of claim 2, wherein the sulfur removal material within the sulfur removal bed (50) further comprises the manganese oxide dispersed over and secured to MnAl₂O₄.

6. A desulfurizing system (80) for a fuel cell power plant (10′) operating on a sulfur-containing fuel, the power plant (10′) having at least one fuel cell (12′) for generating electrical current from a gaseous, hydrogen-rich reformate fuel stream and an oxidant stream, the desulfurizing system (80) comprising:
a. a reformer (42′) secured in fluid communication through a fuel feed line (44′) with a fuel source (30′) for reforming the fuel into the gaseous, hydrogen-rich reformate fuel stream, and the reformer (30′) secured in fluid communication with a gaseous fuel inlet line (24′) for directing the gaseous reformate fuel stream into the fuel cell (12′);
b. a first sulfur removal bed (82) secured in fluid communication with and between the reformer (42′) and the fuel cell (12′), a second sulfur removal bed (88) secured in fluid communication with and between the reformer (42′) and the fuel cell (12′) the first sulfur bed (82) and the second sulfur removal bed (88) each including sulfur removal material consisting of manganese oxide secured to a support material and the beds (82, 88) configured to direct flow of the gaseous reformate fuel stream adjacent the sulfur removal material to remove sulfur from the gaseous reformate fuel stream, the first sulfur bed (82) including a first regeneration-fluid inlet (104), the second sulfur removal bed including a second regeneration-fluid inlet (108), each regeneration fluid inlet (104, 108) configured to intermittently direct flow of a regeneration fluid through the first and second sulfur removal beds (82, 88) adjacent the sulfur removal material;
c. a first reformer isolation valve (86) secured between the first sulfur removal bed (82) and the reformer (42′), a first fuel cell isolation valve (87) secured between the first sulfur removal bed (82) and the fuel cell (12′), a second reformer isolation valve (92) secured between the second sulfur removal bed (88) and the reformer (42′), a second fuel cell isolation valve (95) secured between the second sulfur removal bed (88) and the fuel cell (12′), and configured so that whenever the first reformer isolation valve (86) and first fuel cell isolation valve (87) are open to direct flow of the hydrogen-rich reformate fuel stream through the first sulfur removal station (82) to the fuel cell (12′), the second reformer isolation valve (92) and second fuel cell isolation valve (95) are closed to prohibit flow of the reformate fuel stream through the second sulfur removal bed (88), and configured so that whenever the first reformer isolation valve (86) and first fuel cell isolation valve (87) are closed, the second reformer isolation valve (92) and second fuel cell isolation valve (95) are open;
d. a sulfur capture bed (54′) secured in fluid communication with the sulfur removal bed (50′), the sulfur capture bed (54′) including sulfur capture material consisting of nickel oxysulfide catalyst supported on silicon carbide and configured to direct flow of a regeneration-produced sulfur containing stream from the sulfur removal bed (50′) through the sulfur capture bed (54′) adjacent the sulfur capture material, the sulfur capture bed including a heat source (60′) configured to intermittently heat the bed, and the sulfur capture bed (54′) including a flush inlet (62′) and flush outlet (64′) configured to permit a flush liquid to intermittently pass through the bed (54′) and adjacent the sulfur capture material; and,
e. a sulfur storage container (70′) secured in fluid communication with the flush outlet (64′) of the sulfur capture bed (54′) for storing sulfur flushed with the flush liquid from the sulfur capture bed (54′).

7. The desulfurizing system (80) of claim 6 further comprising a fuel exhaust feed line (72′) secured in fluid communication with a fuel exhaust (26′) for directing fuel exhaust from the fuel cell (12′) and with a first regeneration-fluid inlet (104) of the first sulfur removal bed (82) and with a second regeneration-fluid inlet (108) of the second sulfur removal bed (88) and configured to selectively, intermittently and separately direct fuel exhaust into one of the first sulfur removal bed (82) and the second sulfur removal bed (88) to remove sulfur from and regenerate the sulfur removal beds (82, 88).

8. The desulfurizing system of claim 7, wherein the sulfur capture material within the sulfur capture bed (54′) further comprises the silicon carbide support defining hydrophilic surface regions configured to capture elemental sulfur from the regeneration-produced sulfur containing stream passing through the sulfur capture bed (54′), and the silicon carbide support material defining hydrophobic surface regions configured for collection of the captured sulfur within a water film on the support material in fluid communication with the flush liquid transporting the sulfur to the sulfur storage container (70′).

9. The desulfurizing system of claim 8, wherein the sulfur removal material within the sulfur removal bed (50) further comprises the manganese oxide dispersed over and secured to MnAl₂O₄.

10. A method of desulfurizing fuel for a fuel cell power plant (10) operating on a sulfur-containing fuel, the power plant (10) having at least one fuel cell (12) for generating electrical current from a gaseous, hydrogen-rich reformate fuel stream and an oxidant stream, the method comprising:
a. directing a sulfur containing hydrogen-rich reformate fuel stream from a reformer (42) into a sulfur removal bed (50);
b. passing the reformate fuel stream adjacent sulfur removal material consisting of manganese oxide secured to a support material within the sulfur removal bed (50);
c. directing the reformate fuel stream from the sulfur removal bed (50) into a fuel cell (12);
d. intermittently directing flow of a regeneration fluid through the sulfur removal bed (50) to remove sulfur from and regenerate the sulfur removal bed 50;
e. directing flow of a regeneration-produced sulfur containing stream from the sulfur removal bed (50) through a sulfur capture bed (54) containing sulfur capture material consisting of a nickel oxysulfide catalyst supported on silicon carbide;
f. then, heating the sulfur capture material to between about one hundred and ten and about one hundred and thirty degrees Celsius while flushing a flush liquid through the sulfur capture bed (54);
g. then directing flow of the flush liquid containing sulfur from the sulfur capture bed (54) to a sulfur storage container (70).

11. The method of desulfurizing of claim 10, wherein the step of intermittently directing flow of a regeneration fluid through the sulfur removal bed (50) comprises the further step of directing the regeneration fluid from one of a fuel exhaust line (26) configured to direct a fuel exhaust out of the fuel cell (12) or a fuel exhaust storage container (78) configured to store a portion of the fuel exhaust of the fuel cell (12).
